(19) United States
(12) Patent Application Publication
(10) Pub. No.: US 2016/0271529 A1
(43) Pub. Date: Sep. 22, 2016

(54) METHOD FOR MANUFACTURING A FILTER FROM SHEET METAL AND A FILTER MANUFACTURED BY THE METHOD

(71) Applicant: CONTROL EXPRESS FINLAND OY, Savonlinna (FI)

(72) Inventors: Tero SALMINEN, Kerimäki (FI); Tapani HANSKI, Savonlinna (FI); Eemelli TOIVANEN, Savonlinna (FI)

(21) Appl. No.: 15/035,092

(22) PCT Filed: Oct. 29, 2014
(86) PCT No.: PCT/FI2014/050810

§ 371 Date: May 6, 2016

(30) Foreign Application Priority Data
Nov. 15, 2013 (FI) 20136130

(51) Int. Cl. B01D 29/03; B01D 39/20; B01D 35/28; B01D 29/01

(52) U.S. Cl. CPC B01D 29/03; B01D 29/012; B01D 39/2027; B01D 35/28

(57) ABSTRACT

A method for manufacturing a filter from sheet metal uses two perforated sheets mounted at a distance from one another, between which is formed a space for a filtered liquid. In the method, on at least one edge of one of the sheets is formed a connecting groove by bending an edge of the sheet. In the connecting groove is placed a connecting part, of either a separate edge strip or of the opposite sheet, in such a way that the said connecting part can be moved to a correct location in the connecting groove, after which the connecting part is connected to the connecting groove by welding.

The object of the present invention is a method for manufacturing a filter from sheet metal and a filter manufactured by the method.

In the various filters currently used, for example, in papermaking for filtering water from the pulp mixture, is typically used a filter body with openings which are covered with a filter doth which is changed at regular intervals. In the centre of the filter body is formed a space for the filtered liquid. Occasionally, more durable wire meshes are used for covering the openings, but they are, however, more expensive to manufacture than filter cloths.

In sheet metal production, it is well known that dimensionally accurate parts which require, for example, welding are difficult to manufacture, because the sheet heats up locally when welded and contracts when it cools. Stresses and deformations are thus formed in the sheet. For the above reason, the aim is to limit welding to a minimum, for example, to spot welding. Perforated sheets naturally present twice the challenge, because at different stages of working, the sheet is highly susceptible to both tearing and warping. From the point of view of filtering, the aim is to have as large an open surface area as possible, but this makes the product more difficult to realise from the point of view of strength.

The problem with forming is that a strain is exerted on the necks between the holes which may be so thin that the sheet will tear at that point. To some extent, forming can be affected by selecting the direction of forming in such a way that it will avoid the thinnest points between the holes and the line of holes.

Another method is to attach to the perforated sheet, for example for edging, a solid sheet to which is made an edge. The problem with this method is that attaching a separate strip to the perforated sheet is done, for example, by spot or seam welding. In that case, the welding melts the metal and heats it. Since there can be hardly any edges on the sheet at this stage, the sheet tends to warp particularly easily and making a dimensionally accurate product becomes more difficult.

The aim of the present invention is to provide a solution which is relatively economical to manufacture and which has a long service life. To achieve this aim, the method according to the invention is characterised by the features disclosed in the characterising part of claim 1.

According to the invention, the filter is preferably implemented as a honeycomb structure with preferably hemispherical embossing's limiting the height dimension of the interior of the filter.

When filters are made of perforated sheet, no separate filter cloth is needed.

The invention is described in greater detail in the following, with reference to the accompanying drawings presented only as diagrammatic examples, wherein:

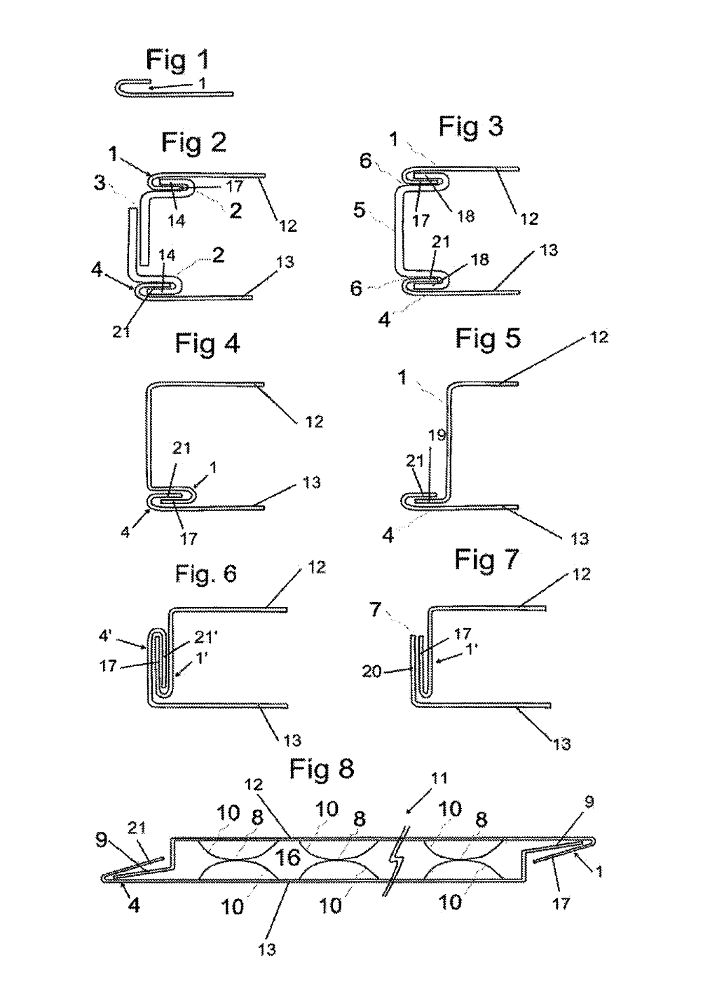

FIG. 1 shows a detail made in the sheet metal in the method according to the invention,

FIGS. 2-3 show two different implementations using separate edge strips as an aid,

FIGS. 4-7 show different filter structures in which the edge areas of opposing sheets are connected to each other without separate edge strips, and

FIG. 8 shows a cross-sectional view of a filter manufactured by the method according to the invention.

In the method according to the invention are used two perforated sheets 12, 13 mounted at a distance from one another, between which is formed a space for filtered liquid. The sheets are connected to each other in their edge areas, preferably by spot welding. FIG. 1 shows a connecting groove 1 made in the edge area of the sheet by edging, which groove is used to help connect the edges of the opposing sheets to one another. The connecting groove 1 is preferably made by bending a strip of desired width from the edge of the sheet upwards by about 90° and by then pressing the strip back towards the surface of the sheet. In the Figure, the strips forming the connecting grooves 1 and 4 are marked with reference numerals 17 and 21, respectively. The connecting groove 1 is preferably dimensioned in such a way that the connecting part placed inside it, which may be, for example, the bent part 14 of a separate edge strip 2 shown in FIG. 2, is set tightly in the groove, but is able to move slightly in the groove to allow the alignment of the edges. Once the connecting part 14 is mounted in the connecting groove 1 of the first sheet 12, the assembly obtained is placed in a guide structure (not shown), where the positions of the edges are calibrated to the precise measurements. This is followed by spot welding, in which case the final measurement of the product is accurate. Dense spot welding is not required because the structure is relatively rigid by nature due to the edged connecting groove 1. A second edge strip 2 is similarly placed in the connecting groove 4 of a second sheet 13 and positioned into the correct position in the guide structure before welding. Finally, two such filter halves are welded at the point 3 between the edge strips 2 in the assembly intended for the guide structure.

When the parts are accurately dimensioned, they can be welded with a diode laser. A diode laser is a good welding method because it exerts a minimum amount of heat on the piece. When using a diode laser, the seam 3 between the welded pieces must be tight because even a small gap in the seam will cause a hole to be formed at that point instead of a fastening weld.

FIG. 3 shows the use of a continuous edge strip 5. The connecting parts connected to the connecting grooves 1 and 4 of the edge strip are marked with reference numeral 18. This continuous edge strip is suitable for use when the sheets 12, 13 are first connected to one another at some other point. In this case, spot welding is then no longer possible, but welding 6 with a diode laser can be done.

The filter structure can also be made without separate strips, that is, only of the sheets 12, 13, if the strength of the structure is sufficient for the intended use. FIGS. 4 to 7 show some alternative implementations. In them, spot welding is possible only in the structure of FIG. 5, the others require either a diode laser or other welding. The structure of FIG. 6 can be realised without welding, but the pressing together of the grooves 1′ and 4′, respectively, edged in the edge part strips 17 and 21′ requires special arrangements, such as, for example, a counter-support pushed inside the structure from the ends. The manner of connection shown in FIG. 4 may also require the use of a counter-support inside the structure during pressing.

The advantage of the structure of FIG. 5 is that the connection between the connecting projection 19 made on the edge of the first sheet 12 and the connecting groove 4 made on the edge of the second sheet can be pressed tight from the outside before welding. This may require separate edge strips, if the element is fixed to the structures by its edges.

The advantage of the structure of FIG. 7 is that if the rigidity is sufficient, the surface sheets 12 and 13 may be welded only at the ends 7 of the sheets, whereby the potential thermal changes are minimal. At the end of surface plate 13 is only one upwards bent strip 20 without a connecting groove.

FIG. 8 shows a filter 11 with a honeycomb structure, in which rigidity Is achieved by forming hemispherical embossing's, or calottes 10, in the sheet. On one edge of each of the opposing sheets 12, 13 is formed a connecting groove 1 and 4, respectively, and on the edge of each sheet opposite with respect to the connecting groove is formed a connecting projection 9. The connecting grooves 1 and 4 are formed on a different edge of the sheets 12, 13 to be placed opposite to one another, whereupon when assembling the sheets, the connecting projection 9 of one sheet is placed inside the connecting groove 1 and 4 respectively, of the opposite sheet, after which the sheets 12, 13 are positioned in alignment and fastened to each other by welding at the points of contact of the calottes 10, preferably by spot welds 8. The edge connections formed by the connecting groove 1, 4 and the corresponding connecting projection 9 of the opposing sheet are finally pressed tightly against one another and, if necessary, possibly fastened to each other by welding.

By means of the method according to the invention can be manufactured, for example, sector-shaped filter elements for use in the disc filters used in papermaking. In these filter elements, the height of the space 16 increases and the width narrows towards the inner end, that is, towards the central shaft of the disc filter. The length of the filter element may be, for example, within the range from 500 to 2000 mm. The hole size in these filter elements is preferably approximately 1 mm, the necks between the holes being approximately 0.5 mm and the thickness of the sheet approximately 1 mm. These dimensions are only examples of some of the preferred embodiments. By means of the method can also be manufactured filters of other shapes, such as rectangular ones.

1-9. (canceled)

10. A method for manufacturing a filter from sheet metal, using two perforated sheets mounted at a distance from one another, which constitute a filter as such without a separate filter cloth or the like, between the two perforated sheets is formed a space for filtered liquid, in which method on at least one edge of one of the two perforated sheets is formed a connecting groove by bending the edge of the sheet, in which connecting groove is placed a connecting part of either a separate edge strip or of the opposing sheet in such a way that the said connecting part can be moved to a correct location in the connecting groove, after which the connecting part is connected to the connecting groove by pressing and/or welding, in which method, in the sheets are first made embossings which are hemispherical or resemble a half of an ellipsoid, which are directed in a direction towards the space formed between the two perforated sheets, and that the opposing two perforated sheets are positioned in such a way that the embossings in one sheet settle against the embossings in corresponding positions in the other sheet and the two perforated sheets are connected to each other by welding them at the point of contact of the embossings.

11. The method as claimed in claim 10, wherein the moving of the connecting part with respect to the connecting groove is carried out in the guide structure, in which the exact positions of the edge parts to be connected are marked.

12. The method as claimed in claim 10, wherein on one edge of each of the opposing two perforated sheets is formed a connecting groove and on the edge of each of the two perforated sheets opposite with respect to the connecting groove is formed a connecting projection, the connecting grooves being formed on a different edge of the sheets to be placed opposite one another, and the connecting projection of one of the two perforated sheets is placed inside the connecting groove of the opposite of the two connecting sheets, after which the two perforated sheets are positioned in alignment and fastened to each other by pressing and/or welding.

13. A method as claimed in claim 10, wherein a spot welding method is used for welding.

14. A filter manufactured according to a method as claimed in claim 10.
